(19) United States
(12) Patent Application Publication
(10) Pub. No.: US 2022/0227233 A1
(43) Pub. Date: Jul. 21, 2022

(54) CONTROL APPARATUS FOR ELECTRICALLY-POWERED VEHICLE, ELECTRICALLY-POWERED VEHICLE, AND CONTROL METHOD FOR ELECTRICALLY-POWERED VEHICLE

(71) Applicant: TOYOTA JIDOSHA KABUSHIKI KAISHA, Toyota-shi (JP)

(72) Inventor: Yusuke TSUZUKI, Toyota-shi (JP)

(73) Assignee: TOYOTA JIDOSHA KABUSHIKI KAISHA, Toyota-shi (JP)

(21) Appl. No.: 17/564,501

(22) Filed: Dec. 29, 2021

(30) Foreign Application Priority Data
Jan. 21, 2021 (JP) 2021-007918

(51) Int. Cl. B60L 7/18; B60L 15/20

(52) U.S. Cl. CPC B60L 7/18; B60L 15/2009; B60L 2250/28; B60W 20/00; B60L 2250/10; B60L 2250/16; B60L 2250/12

(57) ABSTRACT

Look-ahead deceleration assistance control includes: accelerator-off guidance control that is control to, when a target location related to deceleration of an electrically-powered vehicle is set, notify a driver of information prompting the driver to release an accelerator pedal; and regeneration increasing control that is control to, when the target location related to deceleration of the electrically-powered vehicle is set, increase a braking force generated by a motor generator as compared to when the target location is not set. The strong regeneration control is control to, when the strong regeneration mode is set by a switch operating unit, increase the braking force in a state where the accelerator pedal is released as compared to the normal mode. The control apparatus is configured to, when the strong regeneration mode is set by the switch operating unit, execute the strong regeneration control and not execute the look-ahead deceleration assistance control.

### CROSS-REFERENCE TO RELATED APPLICATION

This application claims priority to Japanese Patent Application No. 2021-007918 filed on Jan. 21, 2021, incorporated herein by reference in its entirety.

### BACKGROUND

### 1. Technical Field

The disclosure relates to a control apparatus for an electrically-powered vehicle, an electrically-powered vehicle, and a control method for an electrically-powered vehicle and, more particularly, to a control apparatus for an electrically-powered vehicle including a motor generator and an accelerator pedal, an electrically-powered vehicle, and a control method for an electrically-powered vehicle.

### 2. Description of Related Art

Look-ahead deceleration assistance control is control to set a location at which an electrically-powered vehicle is predicted to end deceleration as a target deceleration end location, to prompt a driver to release an accelerator pedal such that the vehicle ends deceleration at the target deceleration end location, and to generate a braking force greater than that during normal times by executing regeneration increasing control in a state where the accelerator pedal is released. Hitherto, there has been an electrically-powered vehicle capable of executing such look-ahead deceleration assistance control (see, for example, Japanese Unexamined Patent Application Publication No. 2017-028749 (JP 2017-028749 A)).

### SUMMARY

In such an electrically-powered vehicle, in a case where accelerator strong regeneration control for increasing a braking force in a state where an accelerator pedal is released is allowed to be executed, when the look-ahead deceleration assistance control is executed during execution of the accelerator strong regeneration control, interference of control may occur or a driver may experience a sense of discomfort.

The disclosure provides a control apparatus for an electrically-powered vehicle, an electrically-powered vehicle, and a control method for an electrically-powered vehicle, which are able to avoid concerns about interference of control and are able to avoid a sense of discomfort experienced by a driver.

An aspect of the disclosure provides a control apparatus that controls an electrically-powered vehicle. The electrically-powered vehicle includes a motor generator configured to generate a driving force of the electrically-powered vehicle by receiving a supply of electric power and generate a braking force by generating an electric power, an accelerator pedal configured to receive an acceleration request from a driver, and a switch operating unit configured to receive driver's operation to switch between a normal mode and a strong regeneration mode. Look-ahead deceleration assistance control includes accelerator-off guidance control and regeneration increasing control. The accelerator-off guidance control is control to, when a target location related to deceleration of the electrically-powered vehicle is set, notify the driver of information prompting the driver to release the accelerator pedal. The regeneration increasing control is control to, when the target location related to deceleration of the electrically-powered vehicle is set, increase the braking force generated by the motor generator as compared to when the target location is not set. The strong regeneration control is control to, when the strong regeneration mode is set by the switch operating unit, increase the braking force in a state where the accelerator pedal is released as compared to the normal mode. The control apparatus is configured to, when the strong regeneration mode is set by the switch operating unit, execute the strong regeneration control, and, when the strong regeneration control is set by the switch operating unit, not execute the look-ahead deceleration assistance control.

With this configuration, when the strong regeneration control is being executed in the strong regeneration mode, the look-ahead deceleration assistance control is configured not to be executed. As a result, it is possible to avoid concerns about interference of control, and it is possible to avoid a sense of discomfort experienced by the driver.

The control apparatus may be configured to, when the strong regeneration mode is set by the switch operating unit at a timing at which the accelerator-off guidance control is able to be started, not start the look-ahead deceleration assistance control, and the control apparatus may be configured to, when the look-ahead deceleration assistance control is not started, and when the normal mode is set by the switch operating unit before a timing at which the look-ahead deceleration assistance control is ended, not execute the accelerator-off guidance control. With this configuration, it is possible to avoid a sense of discomfort experienced by the driver.

The control apparatus may be configured to, when the look-ahead deceleration assistance control is not started, and when the normal mode is set by the switch operating unit before a timing at which the look-ahead deceleration assistance control is ended, execute the regeneration increasing control. With this configuration, it is possible to avoid concerns about interference of control.

Another aspect of the disclosure provides an electrically-powered vehicle. The electrically-powered vehicle includes a motor generator configured to generate a driving force of the electrically-powered vehicle by receiving a supply of electric power and generate a braking force by generating an electric power, an accelerator pedal configured to receive an acceleration request from a driver, a switch operating unit configured to receive driver's operation to switch between a normal mode and a strong regeneration mode, and a control apparatus configured to control the motor generator. Look-ahead deceleration assistance control includes accelerator-off guidance control and regeneration increasing control. The accelerator-off guidance control is control to, when a target location related to deceleration of the electrically-powered vehicle is set, notify the driver of information prompting the driver to release the accelerator pedal. The regeneration increasing control is control to, when the target location related to deceleration of the electrically-powered vehicle is set, increase the braking force generated by the motor generator as compared to when the target location is not set. The strong regeneration control is control to, when the strong regeneration mode is set by the switch operating unit, increase the braking force in a state where the accelerator pedal is released as compared to the normal mode. The control apparatus is configured to, when the strong regeneration mode is set by the switch operating unit, execute the strong regeneration control, and, when the strong regeneration mode is set by the switch operating unit, not execute the look-ahead deceleration assistance control.

With this configuration, it is possible to avoid concerns about interference of control, and it is possible to avoid a sense of discomfort experienced by the driver.

Further another aspect of the disclosure provides a control method for an electrically-powered vehicle. The electrically-powered vehicle includes a control apparatus that executes the control method. The electrically-powered vehicle includes a motor generator configured to generate a driving force of the electrically-powered vehicle by receiving a supply of electric power and generate a braking force by generating an electric power, an accelerator pedal configured to receive an acceleration request from a driver, and a switch operating unit configured to receive driver's operation to switch between a normal mode and a strong regeneration mode. Look-ahead deceleration assistance control includes accelerator-off guidance control and regeneration increasing control. The accelerator-off guidance control is control to, when a target location related to deceleration of an electrically-powered vehicle is set, notify the driver of information prompting the driver to release the accelerator pedal. The regeneration increasing control is control to, when the target location related to deceleration of the electrically-powered vehicle is set, increase the braking force generated by the motor generator as compared to when the target location is not set. The strong regeneration control is control to, when the strong regeneration mode is set by the switch operating unit, increase the braking force in a state where the accelerator pedal is released as compared to the normal mode. The control method includes, when the strong regeneration mode is set by the switch operating unit, executing, by the control apparatus, the strong regeneration control, and, when the strong regeneration mode is set by the switch operating unit, prohibiting, by the control apparatus, the look-ahead deceleration assistance control.

With this configuration, it is possible to avoid concerns about interference of control, and it is possible to avoid a sense of discomfort experienced by the driver.

According to the disclosure, it is possible to provide a control apparatus for an electrically-powered vehicle, an electrically-powered vehicle, and a control method for an electrically-powered vehicle, which are able to avoid concerns about interference of control and are able to avoid a sense of discomfort experienced by a driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall block diagram of a vehicle according to an embodiment of the disclosure;

FIG. 2 is a view schematically showing an example of changes in vehicle speed and deceleration level in a case where look-ahead deceleration assistance control is executed according to the embodiment;

FIG. 3 is a block diagram showing an example of regeneration increasing control according to the embodiment;

FIG. 4 is a flowchart showing the flow of an accelerator strong regeneration process according to the embodiment;

FIG. 5A is a view showing a driving force map in a B range according to the embodiment;

FIG. 5B is a view showing a driving force map during accelerator strong regeneration control according to the embodiment;

FIG. 6 is a flowchart showing the flow of a look-ahead deceleration assistance process according to the embodiment;

FIG. 7A is a graph for illustrating a method of calculating an assistance start timing according to the embodiment;

FIG. 7B is a graph for illustrating a method of calculating an assistance start timing according to the embodiment;

FIG. 7C is a graph for illustrating a method of calculating an assistance start timing according to the embodiment; and

FIG. 8 is a timing chart showing an example of a control result through execution of the look-ahead deceleration assistance process according to the embodiment.

### DETAILED DESCRIPTION OF EMBODIMENTS

Hereinafter, an embodiment of the disclosure will be described with reference to the accompanying drawings. In the following description, like reference signs denote the same components. The names and functions of those components are also the same. Therefore, the detailed description thereof will not be repeated.

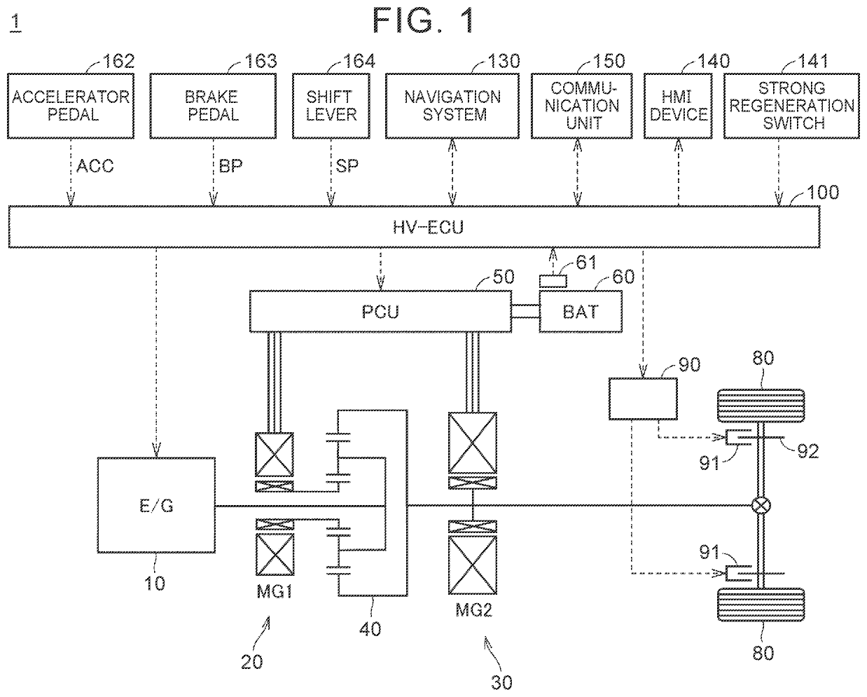

FIG. 1 is an overall block diagram of a vehicle 1 according to the embodiment of the disclosure. The vehicle 1 includes an engine 10, a first motor generator (hereinafter, also referred to as first MG) 20, a second motor generator (hereinafter, also referred to as second MG) 30, a power split device 40, a power control unit (PCU) 50, a battery 60, drive wheels 80, a friction brake generating circuit 90, a hybrid vehicle electronic control unit (HV-ECU) 100, an accelerator pedal 162, a brake pedal 163, a shift lever 164, a navigation system 130, a communication unit 150, a human machine interface (HMI) device 140, and a strong regeneration switch 141.

The vehicle 1 is a hybrid vehicle that runs by using at least one of the power of the engine 10 and the power of the second MG 30. A vehicle to which control described in the embodiment is applicable just needs to be an electrically-powered vehicle that includes at least a drive motor generator and is not limited to a hybrid vehicle.

A power generated by the engine 10 is distributed by the power split device 40 to a path through which a power is transmitted to the drive wheels 80 and a path through which a power is transmitted to the first MG 20.

The first MG 20 and the second MG 30 each are a three-phase alternating-current rotating electrical machine that is driven by the PCU 50. The first MG 20 generates electric power by using part of the power of the engine 10, split by the power split device 40.

The second MG 30 generates the driving force of the vehicle 1 by using at least any one of electric power stored in the battery 60 and electric power generated by the first MG 20. The second MG 30 performs regenerative power generation by using the kinetic energy of the vehicle 1, transmitted from the drive wheels 80, during coasting in an accelerator off state (in a state where a driver is not depressing the accelerator pedal 162). A regenerative electric power generated by the second MG 30 is charged into the battery 60.

The power split device 40 is a planetary gear train including a sun gear, pinion gears, a carrier, and a ring gear. The pinion gears are in mesh with each of the sun gear and the ring gear. The carrier supports the pinion gears such that the pinion gears are rotatable. The carrier is coupled to the crankshaft of the engine 10. The sun gear is couple to the rotary shaft of the first MG 20. The ring gear is coupled to the rotary shaft of the second MG 30 and the drive wheels 80.

When the power split device 40 has the above-described configuration, the rotation speed of the first MG 20 (the rotation speed of the sun gear), the rotation speed of the engine 10 (the rotation speed of the carrier), and the rotation speed of the second MG 30 (the rotation speed of the ring gear) have a relationship represented by a straight line on a nomograph (a relationship in which, when any two rotation speeds are determined, the remaining rotation speed is also determined; hereinafter, also referred to as nomograph relationship).

By adjusting the rotation speed of the first MG 20 coupled to the sun gear as needed, the power split device 40 functions as an electrical continuously variable transmission capable of continuously changing the ratio between the rotation speed of the drive wheels 80 (that is, vehicle speed V) coupled to the ring gear and the rotation speed of the engine 10 coupled to the carrier.

The PCU 50 converts direct-current power stored in the battery 60 to alternating-current power by which the first MG 20 and the second MG 30 can be driven. The PCU 50 converts alternating-current power generated by the first MG 20 and the second MG 30 to direct-current power by which the battery 60 can be charged.

The battery 60 is configured to include a secondary battery, such as a nickel metal-hydride battery and a lithium ion secondary battery. The battery 60 is charged with electric power generated by at least one of the first MG 20 and the second MG 30. A monitoring unit 61 is attached to the battery 60. The monitoring unit 61 detects the voltage, current, and temperature of the battery 60 and outputs detection results to the HV-ECU 100.

The friction brake generating circuit 90 supplies brake calipers 91 with a brake fluid pressure corresponding to a control signal from the HV-ECU 100. A brake pad of each brake caliper 91 is pressed against a brake disc 92 by the brake fluid pressure, with the result that rotation of the brake disc 92 is restricted by friction generated between the brake disc 92 and the brake pad. Thus, the kinetic energy of the vehicle 1 is converted to thermal energy, and friction brake is applied.

The accelerator pedal 162 includes an accelerator pedal sensor. The accelerator pedal sensor detects the operation amount (hereinafter, also referred to as accelerator operation amount) ACC of the accelerator pedal 162 by the driver. The brake pedal 163 includes a brake pedal sensor. The brake pedal sensor detects the operation amount BP of a brake pedal 163 by the driver. A shift lever 164 includes a shift sensor. The shift sensor detects the position (hereinafter, also referred to as shift position) SP of the shift lever 164 operated by the driver. These sensors output detection results to the HV-ECU 100.

The navigation system 130 includes a global positioning system (GPS) and map data. The navigation system 130 computes host vehicle location information from the GPS, road shape information around a host vehicle location obtained by consulting the map data, travel route information set by the driver, and the like in response to a request from the HV-ECU 100 and outputs these pieces of information to the HV-ECU 100.

The navigation system 130 stores information on locations at which the vehicle 1 has decelerated in the past and locations at which the vehicle 1 has stopped in the past and learns the stop locations and deceleration locations of the vehicle 1 from the history. The navigation system 130 outputs the learned stop locations and deceleration locations (hereinafter, also referred to as learned stop/deceleration locations) to the HV-ECU 100 in response to a request from the HV-ECU 100. Stop and deceleration locations may be learned by the HV-ECU 100 based on information from the navigation system 130.

The communication unit 150 acquires infrastructure information, such as information about traffic lights (for example, traffic light cycles) around the host vehicle, road alignment information, and road traffic information (for example, traffic congestion information or regulatory information), by communicating with a roadside machine (for example, a broadcast medium, such as an optical beacon) installed in a road, a traffic light, or the like, and outputs the acquired information to the HV-ECU 100.

The HMI device 140 is a device that provides the driver with various pieces of information for assisting in driving the vehicle 1. The HMI device 140 includes, for example, a display, a speaker, and the like provided in the cabin of the vehicle 1. Another existing device, for example, the display and the speaker of the navigation system 130, may be used as the HMI device 140.

When the strong regeneration switch 141 is set to an on state by the driver, accelerator strong regeneration control is executed. When the strong regeneration switch 141 is set to an off state, accelerator strong regeneration control is ended, and normal regeneration control different from the accelerator strong regeneration control is executed. The accelerator strong regeneration control is control to increase a braking force when the accelerator is off by increasing a regenerative electric power generated by the second MG 30 when the accelerator is off as compared to when no accelerator strong regeneration control is executed.

In the accelerator strong regeneration control, control to increase the braking force of engine braking generated by the engine 10 (or control to increase the braking force of a braking device different from friction brake) in addition to control to increase a regenerative electric power may be executed or control to increase the braking force of engine braking generated by the engine 10 (or control to increase the braking force of a braking device different from friction brake) may be executed instead of control to increase a regenerative electric power. The accelerator strong regeneration control according to the embodiment will be described in detail below.

Although not shown in the drawing, the vehicle 1 includes a plurality of sensors for detecting various physical quantities used to control the vehicle 1, such as a vehicle speed sensor that detects the vehicle speed V. The sensors output detection results to the HV-ECU 100.

The HV-ECU 100 incorporates a central processing unit (CPU) and a memory and executes predetermined arithmetic processing based on information stored in the memory and information from the sensors. The HV-ECU 100 controls devices such as the engine 10, the PCU 50, the friction brake generating circuit 90, and the HMI device 140 based on the result of arithmetic processing.

For example, when the driver is depressing (operating) the accelerator pedal 162, the HV-ECU 100 calculates a required driving force from an accelerator operation amount ACC, a vehicle speed V, and the like, and controls the outputs of the engine 10, the first MG 20, and the second MG 30 such that the required driving force is satisfied.

When the driver is depressing (operating) the brake pedal 163, the HV-ECU 100 calculates a required brake force from an operation amount BP of the brake pedal 163, a vehicle speed V, and the like and controls a regenerative brake force and a friction brake force such that the required brake force is satisfied.

The HV-ECU 100 calculates the state of charge (SOC) of the battery 60. Generally, the SOC is expressed by the ratio of an actual amount of electricity to a full charge capacity. Various known methods, such as a method of calculating the SOC by using the relationship between the voltage of the battery 60 and SOC and a method of calculating the SOC by using an integrated value of current of the battery 60, may be used to calculate the SOC. Hereinafter, a battery SOC is referred to as battery SOC or simply referred to as SOC.

The HV-ECU 100 sets an acceptable power of the battery 60 (in units of watt; hereinafter, also referred to as battery acceptable power Win or simply referred to as acceptable power Win) based on a battery SOC, a temperature, and the like. For example, when the temperature of the battery 60 falls outside a predetermined range (when the temperature of the battery 60 higher than an upper limit temperature of the predetermined range or lower than a lower limit temperature of the predetermined range), the HV-ECU 100 limits the absolute value of the acceptable power Win to a value less than a predetermined value W1. As the battery SOC increases (as the battery SOC approaches 100% that is a value in a full charge state), the HV-ECU 100 limits the battery acceptable power Win to a lower value. The HV-ECU 100 controls an electric power generated by the first MG 20 and the second MG 30 such that the electric power input to the battery 60 does not become higher than the battery acceptable power Win.

### Regeneration Increasing Control

The HV-ECU 100 is capable of executing regeneration increasing control as control for assisting the vehicle 1 in energy-saving driving. Regeneration increasing control is control to, when the vehicle 1 is predicted to stop or decelerate while the vehicle 1 is running, specifically, when there is a point where the vehicle 1 is predicted to stop (hereinafter, also referred to as target stop location) or a point where the vehicle 1 is predicted to decelerate (hereinafter, also referred to as target deceleration location) ahead of the vehicle 1 along a travel route, increase the deceleration obtained through regeneration of the second MG 30 (that is, regenerative electric power) during coasting in an accelerator off state. When the regeneration increasing control is executed, the amount of electric power regenerated during coasting before reaching a target stop location or a target deceleration location (hereinafter, also referred to as target stop/deceleration location) is increased as compared to the amount of electric power regenerated during normal times, a loss of regenerative energy (a situation in which part of the kinetic energy of the vehicle 1 is converted to heat or the like due to the operation of the friction brake, or the like and discarded) is reduced.

In the present embodiment, the HV-ECU 100 sets a target stop/deceleration location based on information from the navigation system 130 and the communication unit 150. Specifically, the HV-ECU 100 determines whether there is a learned stop/deceleration location ahead of the vehicle 1 along a travel route based on information from the navigation system 130, and, when there is a learned stop/deceleration location, sets the learned location as a target stop/deceleration location. The HV-ECU 100 receives a traffic light cycle at an intersection ahead in a travel route with the communication unit 150 from a roadside machine installed at the intersection and, when the vehicle 1 is predicted to stop at the intersection from the received traffic light cycle, sets the intersection as a target stop/deceleration location. A method of setting a target stop/deceleration location is not limited to the above-described ones. For example, when the vehicle 1 includes a device (a camera, a radar, or the like) that detects an inter-vehicle distance and a relative acceleration to a preceding vehicle, and when the host vehicle is predicted to decelerate based on information from the device, the vehicle 1 is able to set a target deceleration location to a point where the vehicle 1 is predicted to decelerate.

The HV-ECU 100 according to the present embodiment starts control to notify the driver by using the HMI device 140 of a guidance (accelerator-off guidance display) for prompting the driver to perform accelerator-off operation (operation to stop depressing the accelerator pedal 162) before executing the regeneration increasing control (hereinafter, referred to as accelerator-off guidance control). Hereinafter, the accelerator-off guidance control and the regeneration increasing control are collectively referred to as look-ahead deceleration assistance control (or simply referred to as assistance control).

In the embodiment, notification through the accelerator-off guidance control is notification with accelerator-off guidance display (for example, display showing that “Release the accelerator” or display of a mark or lamp prompting the driver to release the accelerator) for prompting the driver to perform accelerator-off operation with the HMI device 140.

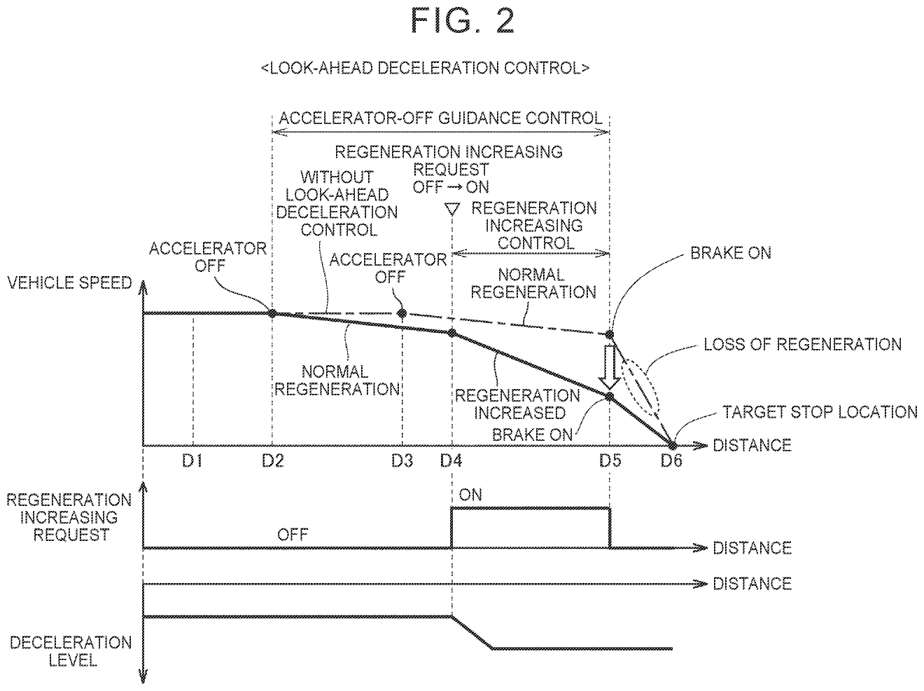

FIG. 2 is a view schematically showing an example of changes in vehicle speed and deceleration level in a case where the look-ahead deceleration assistance control is executed according to the embodiment. In FIG. 2, the abscissa axis represents travel distance (travel location), the top-side ordinate axis represents vehicle speed, and the bottom-side ordinate axis represents deceleration level. In FIG. 2, an example of changes in the case where the look-ahead deceleration assistance control is executed is indicated by the continuous line, and an example of changes in the case where the look-ahead deceleration assistance control is not executed is indicated by the alternate long and short dashed line.

FIG. 2 shows an example in which it is determined that a target stop location is present at a location D6 ahead along a travel route. As described above, the target stop location is calculated based on information from the navigation system 130 and the communication unit 150. Examples of the target stop location include a stop line before an intersection, a stop line before a crosswalk, a stop line before a T-intersection, and a stop line.

When the vehicle 1 reaches a predetermined location D1 before the target stop location D6 along the travel route, the HV-ECU 100 calculates an optimal start location D4 to start the regeneration increasing control from a vehicle speed at that time and a remaining distance to the target stop location D6.

When the vehicle 1 reaches a predetermined location D2 before the calculated start location D4 along the travel route, the HV-ECU 100 starts the accelerator-off guidance control. When the driver who is aware of the guidance performs accelerator-off operation, normal regeneration is started. Normal regeneration is regeneration control during coasting in an accelerator-off state and when the regeneration increasing control is not being executed.

After that, when the vehicle 1 reaches the start location D4, the HV-ECU 100 determines that a regeneration increasing request has changed from an off state to an on state and starts the regeneration increasing control. In the regeneration increasing control, a deceleration caused by regeneration (regenerative electric power) is increased as compared to during normal regeneration. For this reason, a larger amount of regenerative energy than that when normal regeneration is continued is collected.

After that, when the driver performs brake-on operation (operation to depress the brake pedal 163) at the time when the vehicle 1 reaches a predetermined location D5, a friction brake force is added, and the vehicle 1 is stopped at the target stop location D6.

When the look-ahead deceleration assistance control is not executed (alternate long and short dashed line), the accelerator-off guidance control is not executed, so the timing (location D3) at which the driver performs accelerator-off operation delays from the timing when the look-ahead deceleration assistance control is executed (location D2). Even during coasting after accelerator-off operation, the regeneration increasing control is not executed, and normal regeneration is performed. For this reason, regenerative energy is not sufficiently collected by the timing (location D5) at which the driver performs brake-on operation, so there is a loss of regenerative energy. In contrast, in the present embodiment, when the look-ahead deceleration assistance control is executed, a loss of regenerative energy is reduced.

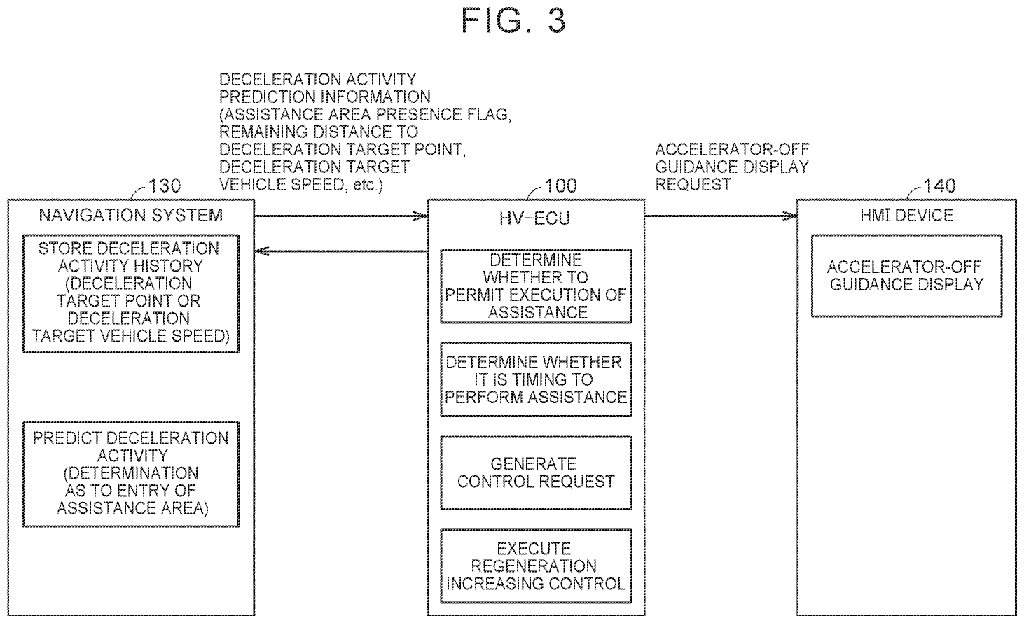

FIG. 3 is a block diagram showing the regeneration increasing control according to the embodiment. As shown in FIG. 3, the navigation system 130 has a function to store a history of deceleration activities of the driver (for example, a deceleration target point, a deceleration target vehicle speed, and the like) and a function to predict a deceleration activity (for example, determination as to entry into an assistance area in which the look-ahead deceleration assistance control is executed). The navigation system 130 transmits deceleration activity prediction information (for example, a flag indicating that the vehicle 1 is present in an assistance area, a remaining distance to a deceleration target point, a deceleration target vehicle speed, and the like) to the HV-ECU 100.

When a deceleration target point is present at a point a predetermined distance ahead along a scheduled travel route (when no scheduled travel route is set, a route along a road on which the vehicle 1 is currently running), it is determined that the vehicle 1 has entered the assistance area. The flag indicating that the vehicle 1 is present in the assistance area is set to an on state during a period from when it is determined that the vehicle 1 has entered the assistance area to when it is determined that the vehicle 1 has reached the deceleration target point.

The HV-ECU 100 has a function to determine whether to permit execution of assistance (regeneration increasing control), a function to determine whether it is the timing to perform assistance, a function to generate a request to execute the assistance control, and a function to perform assistance (regeneration increasing control). When the flag indicating that the vehicle 1 is present in the assistance area is received, an assistance start timing is computed by using information on the remaining distance to the deceleration target point and the deceleration target vehicle speed from the navigation system 130.

The HV-ECU 100 transmits a request for the accelerator-off guidance control to the HMI device 140. The HMI device 140 has a function of accelerator-off guidance display.

### Accelerator Strong Regeneration Control

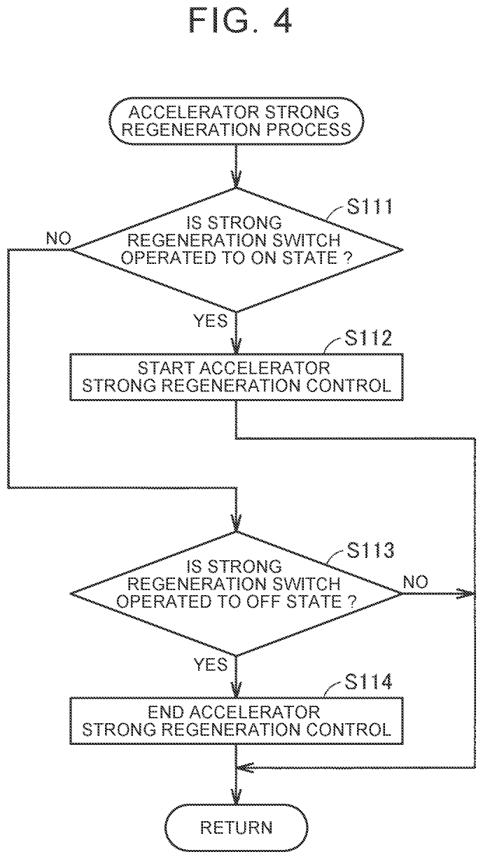

FIG. 4 is a flowchart showing the flow of an accelerator strong regeneration process according to the embodiment. The accelerator strong regeneration process is called and executed at predetermined control intervals from a host process. As shown in FIG. 4, the CPU of the HV-ECU 100 determines whether the strong regeneration switch 141 is operated to the on state (step S111). When the CPU of the HV-ECU 100 determines that the strong regeneration switch 141 is operated to the on state (YES in step S111), the CPU of the HV-ECU 100 starts the accelerator strong regeneration control (step S112).

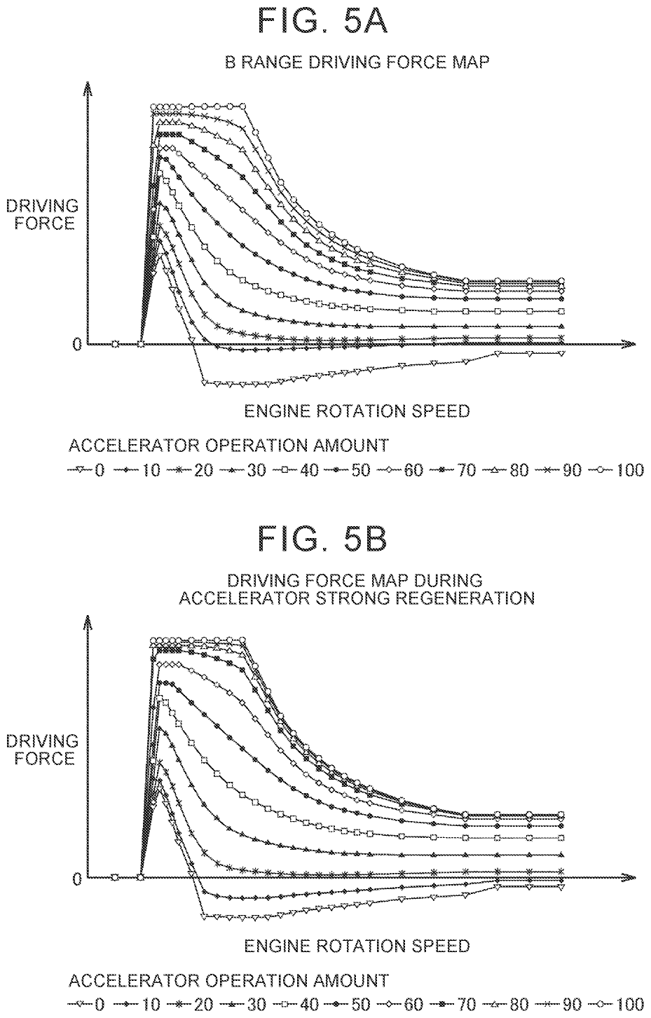

FIG. 5A is a view showing a driving force map in a B range according to the embodiment, and FIG. 5B is a view showing a driving force map during the accelerator strong regeneration control according to the embodiment. FIG. 5A shows the driving force map in the B range. FIG. 5B shows the driving force map during the accelerator strong regeneration control. As shown in FIG. 5A and FIG. 5B, in the accelerator strong regeneration control, it is assumed that the driving force of the vehicle 1 at 0% of the accelerator operation amount ACC (in FIG. 5A and FIG. 5B, negative driving force=deceleration force) is equivalent to a driving force at the time when the shift position is in the B range. The B range is a shift range in which a stronger braking force is applied when the accelerator is off as compared to a D range for normal forward running.

During the accelerator strong regeneration control, the response of driving force when the accelerator operation amount ACC increases differs from the response in the B range. For example, at 10% of the accelerator operation amount ACC, during the accelerator strong regeneration control, a negative driving force (deceleration force) is greater at any engine rotation speed as compared to when the shift range is the B range.

Referring back to FIG. 4, when the CPU of the HV-ECU 100 determines that the strong regeneration switch 141 is not operated to the on state (NO in step S111), the CPU of the HV-ECU 100 determines whether the strong regeneration switch 141 is operated to the off state (step S113). When the CPU of the HV-ECU 100 determines that the strong regeneration switch 141 is operated to the off state (YES in step S113), the CPU of the HV-ECU 100 ends the accelerator strong regeneration control and returns to the normal regeneration control (step S114).

After step S112, after step S114, or when the CPU of the HV-ECU 100 determines that the strong regeneration switch 141 is not operated to the off state (NO in step S113), the CPU of the HV-ECU 100 returns the process to be executed to the host process that is a source calling the accelerator strong regeneration process.

### Look-Ahead Deceleration Assistance Control

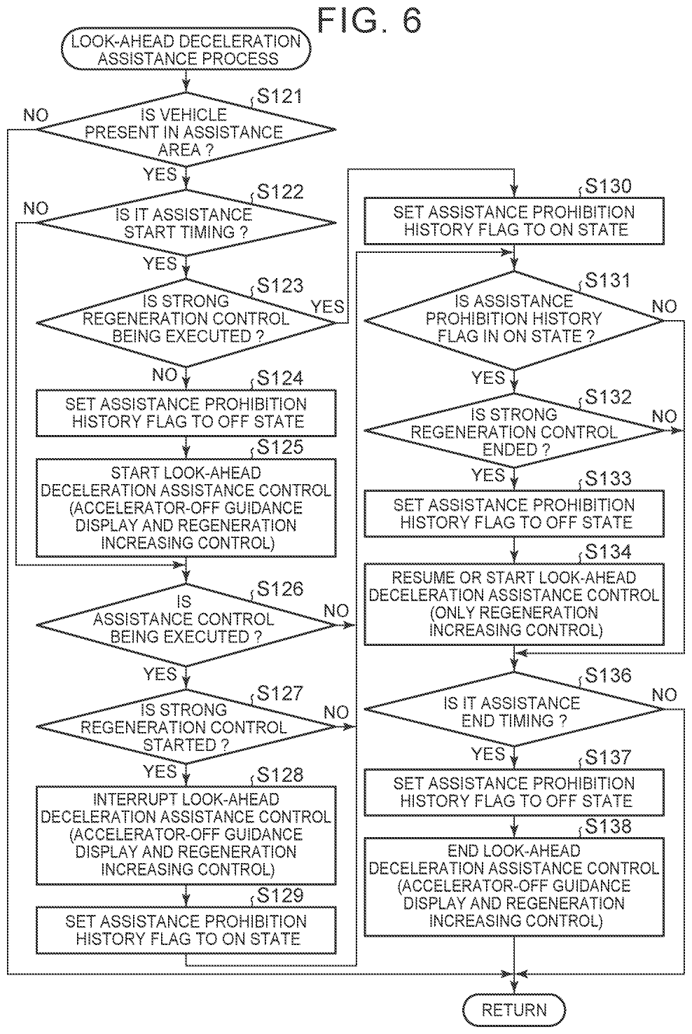

FIG. 6 is a flowchart showing the flow of a look-ahead deceleration assistance process according to the embodiment. The look-ahead deceleration assistance process is called and executed at predetermined control intervals from the host process. As shown in FIG. 6, the CPU of the HV-ECU 100 determines whether the vehicle 1 is present in the assistance area based on information from the navigation system 130 (step S121).

When the CPU of the HV-ECU 100 determines that the vehicle 1 is present in the assistance area (YES in step S121), the CPU of the HV-ECU 100 determines whether it is the timing to start the look-ahead deceleration assistance control based on information from the navigation system 130 (step S122).

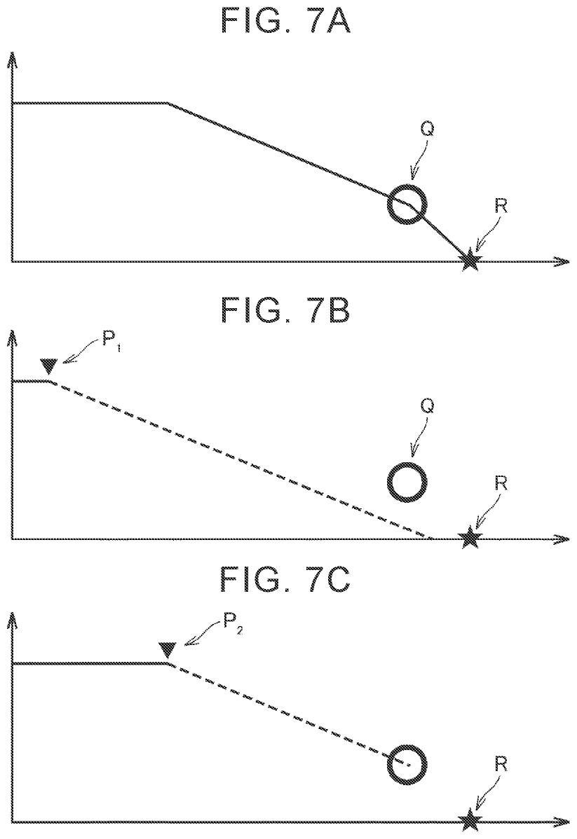

FIG. 7A, FIG. 7B, and FIG. 7C are graphs for illustrating a method of calculating an assistance start timing according to the embodiment. As shown in FIG. 7A, the assistance start timing is calculated such that a specific vehicle speed is obtained when the vehicle 1 reaches circle mark point Q a specific distance before a deceleration target point indicated by star mark point R and sudden brake does not occur.

As shown in FIG. 7B, a vehicle speed at point Q in the case where the accelerator pedal 162 is released from a current vehicle speed at inverted triangle mark point P1 in the assistance area is computed. When the vehicle speed is lower than an intended specific vehicle speed, the vehicle 1 is too decelerated, that is, it is early to release the accelerator pedal 162, so it is not determined that it is the assistance start timing at point P1.

As shown in FIG. 7C, a vehicle speed at point Q in the case where the accelerator pedal 162 is released from a current vehicle speed at inverted triangle mark point P2 in the assistance area is computed. When the vehicle speed is higher than or equal to the intended specific vehicle speed, it is determined that it is the assistance start timing at point P2.

When the CPU of the HV-ECU 100 determines that it is the assistance start timing (YES in step S122), the CPU of the HV-ECU 100 determines whether the accelerator strong regeneration control started in step S112 of FIG. 4 is being executed (step S123). When the CPU of the HV-ECU 100 determines that the accelerator strong regeneration control is being executed (YES in step S123), the CPU of the HV-ECU 100 sets an assistance prohibition history flag to an on state (step S130). The assistance prohibition history flag is a flag indicating whether the look-ahead deceleration assistance control is interrupted as a result of the fact that the accelerator strong regeneration control is started during execution of the look-ahead deceleration assistance control. When the accelerator strong regeneration control is being executed and the look-ahead deceleration assistance control cannot be started at the assistance start timing or when the look-ahead deceleration assistance control is interrupted, the assistance prohibition history flag is set to the on state.

When the CPU of the HV-ECU 100 determines that the accelerator strong regeneration control is not being executed (NO in step S123), the CPU of the HV-ECU 100 sets the assistance prohibition history flag to an off state (step S124) and starts the look-ahead deceleration assistance control (the accelerator-off guidance display and the regeneration increasing control) (step S125).

When the CPU of the HV-ECU 100 determines that it is not the assistance start timing (NO in step S122) or after step S125, the CPU of the HV-ECU 100 determines whether the look-ahead deceleration assistance control is being executed (step S126).

When the CPU of the HV ECU 100 determines that the look-ahead deceleration assistance control is being executed (YES in step S126), the CPU of the HV-ECU 100 determines whether it is the timing at which the accelerator strong regeneration control is started in step S112 shown in FIG. 4 (the timing to execute the step for the first time just after the accelerator strong regeneration control is started) (step S127).

When the CPU of the HV-ECU 100 determines that it is the timing at which the accelerator strong regeneration control is started (YES in step S127), the CPU of the HV-ECU 100 interrupts the look-ahead deceleration assistance control (the accelerator-off guidance display and the regeneration increasing control) (step S128) and sets the assistance prohibition history flag to the on state (step S129).

When the CPU of the HV-ECU 100 determines that the look-ahead deceleration assistance control is not being executed (NO in step S126), when the CPU of the HV-ECU 100 determines that it is not the timing at which the accelerator strong regeneration control is started (NO in step S127), after step S129, or after step S130, the CPU of the HV-ECU 100 determines whether the assistance prohibition history flag is in the on state (step S131).

When the CPU of the HV-ECU 100 determines that the assistance prohibition history flag is in the on state (YES in step S131), the CPU of the HV-ECU 100 determines whether it is the timing at which the accelerator strong regeneration control is ended (the timing to execute the step for the first time just after the accelerator strong regeneration control is ended) (step S132).

When the CPU of the HV-ECU 100 determines that it is the timing at which the accelerator strong regeneration control is ended (YES in step S132), the CPU of the HV-ECU 100 sets the assistance prohibition history flag to the off state (step S133) and resumes or starts only the regeneration increasing control in the look-ahead deceleration assistance control (does not resume or start the accelerator-off guidance control in the look-ahead deceleration assistance control) (step S134).

When the CPU of the HV-ECU 100 determines that the assistance prohibition history flag is not in the on state (NO in step S131), when the CPU of the HV-ECU 100 determines that it is not the timing at which the accelerator strong regeneration control is ended (NO in step S132), or after step S134, the CPU of the HV-ECU 100 determines whether it is the timing to end the look-ahead deceleration assistance control based on information from the navigation system 130 (step S136).

When the CPU of the HV-ECU 100 determines that it is an assistance end timing (YES in step S136), the CPU of the HV-ECU 100 sets the assistance prohibition history flag to the off state (step S137) and ends the look-ahead deceleration assistance control (the accelerator-off guidance display and the regeneration increasing control) (step S138).

When the CPU of the HV-ECU 100 determines that the vehicle 1 is not present in the assistance area (NO in step S121), when the CPU of the HV-ECU 100 determines that it is not the assistance end timing (NO in step S136), or after step S138, the CPU of the HV-ECU 100 returns the process to be executed to the host process that is a source calling the look-ahead deceleration assistance process.

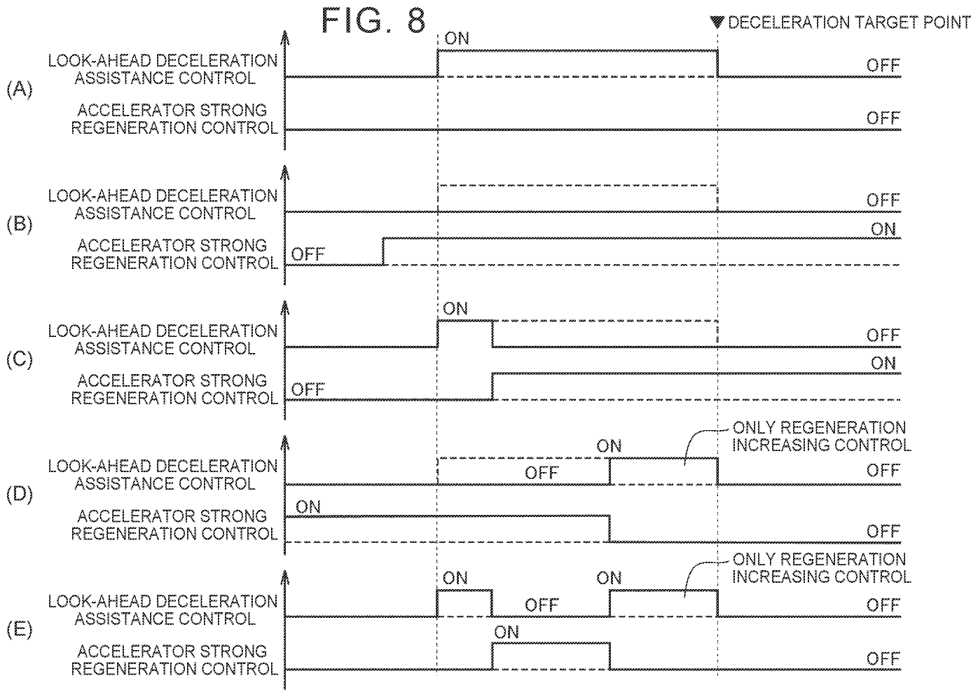

FIG. 8 is a timing chart showing an example of a control result through execution of the look-ahead deceleration assistance process according to the embodiment. As shown in (A) of FIG. 8, in the case where the accelerator strong regeneration control is not executed, when the look-ahead deceleration assistance control is started from the assistance start timing, the look-ahead deceleration assistance control is executed up to the deceleration target point and then stropped.

As shown in (B) of FIG. 8, when the accelerator strong regeneration control is executed from before the assistance start timing comes to after the vehicle 1 reaches the deceleration target point, the look-ahead deceleration assistance control is not executed.

As shown in (C) of FIG. 8, when, after the look-ahead deceleration assistance control is started, the accelerator strong regeneration control is started and is executed to after the vehicle 1 reaches the deceleration target point, the look-ahead deceleration assistance control is interrupted at the timing at which the accelerator strong regeneration control is started, and, after that, not resumed.

As shown in (D) of FIG. 8, when the accelerator strong regeneration control is executed from before the assistance start timing comes to after the vehicle 1 reaches the deceleration target point, the look-ahead deceleration assistance control is not executed as in the case of (B) of FIG. 8. After that, when the accelerator strong regeneration control is ended, only the regeneration increasing control in the look-ahead deceleration assistance control is started and executed up to the deceleration target point, and then stopped.

As shown in (E) of FIG. 8, when, after the look-ahead deceleration assistance control is started, the accelerator strong regeneration control is started, the look-ahead deceleration assistance control is interrupted at the timing at which the accelerator strong regeneration control is started. After that, when the accelerator strong regeneration control is ended, only the regeneration increasing control in the look-ahead deceleration assistance control is resumed and executed up to the deceleration target point, and then stopped.

### Modification

(1) In the above-described embodiment, the vehicle 1 is a hybrid vehicle including the engine 10, the first MG 20, and the second MG 30 as driving sources. However, the configuration is not limited thereto. The vehicle 1 just needs to be an electrically-powered vehicle including a motor generator as a driving source and does not need to include the engine 10.

(2) In the above-described embodiment, as shown in FIG. 2, a target location related to deceleration of the vehicle 1 in the look-ahead deceleration assistance control is the target stop location D6. However, the configuration is not limited thereto. A target location related to deceleration of the vehicle 1 may be a target location to start deceleration of the vehicle 1.

(3) In the above-described embodiment, as shown in FIG. 4 to FIG. 5B, when the accelerator pedal 162 is released in the accelerator strong regeneration control, control to increase a regenerative electric power as compared to when the accelerator strong regeneration control is not executed is executed. However, the configuration is not limited thereto. When the brake pedal 163 is depressed in the accelerator strong regeneration control, control to increase a regenerative electric power as compared to when the accelerator strong regeneration control is not executed may be executed.

(4) In the above-described embodiment, in the accelerator strong regeneration control, when the accelerator pedal 162 is released, a braking force generated by the second MG 30 is increased. However, the configuration is not limited thereto. In addition to the braking force generated by the second MG 30 or instead of the braking force generated by the second MG 30, the braking force of engine braking generated by the engine 10 may be increased (for example, the intake resistance of the engine 10 may be increased, or the exhaust resistance may be increased).

(5) In the above-described embodiment, as shown in step S131 to step S134 in FIG. 6, (D) of FIG. 8, and (E) of FIG. 8, when the accelerator strong regeneration control ends in a period from the assistance start timing to the timing at which the vehicle 1 reaches the deceleration target point, the accelerator-off guidance display in the look-ahead deceleration assistance control is not started or resumed, while the regeneration increasing control in the look-ahead deceleration assistance control is started or resumed. However, the configuration is not limited thereto. Even when the accelerator strong regeneration control ends in a period from the assistance start timing to the timing at which the vehicle 1 reaches the deceleration target point, not only the accelerator-off guidance display is not started or resumed but also the regeneration increasing control does not need to be started or resumed.

(6) In the above-described embodiment, as illustrated in FIG. 1, notification through the accelerator-off guidance control is notification through the accelerator-off guidance display for prompting the driver to perform accelerator-off operation on the HMI device 140. However, the configuration is not limited thereto. Notification through the accelerator-off guidance control may be notification by hiding specific display (for example, display of an eco lamp indicating that the vehicle 1 is running with a small energy consumption) on the HMI device 140 or may be notification through voice for prompting the driver to perform accelerator-off operation from the speaker of the HMI device 140.

### SUMMARY

(1) As shown in FIG. 1, an electrically-powered vehicle (for example, the vehicle 1) that is controlled by a control apparatus (for example, the HV-ECU 100) generates a driving force of the electrically-powered vehicle by receiving a supply of electric power, and includes a motor generator (for example, the second MG 30) that generates a braking force by generating an electric power, an accelerator pedal (for example, the accelerator pedal 162) that accepts an acceleration request from a driver, and a switch operating unit (for example, the strong regeneration switch 141) that accepts driver's operation to switch between a normal mode (for example, a state where the accelerator strong regeneration control is not executed and the normal regeneration control is being executed) and a strong regeneration mode (for example, a state where the accelerator strong regeneration control is being executed).

As shown in FIG. 2 and FIG. 3, look-ahead deceleration assistance control includes accelerator-off guidance control and regeneration increasing control. The accelerator-off guidance control is control to notify the driver of information prompting the driver to release the accelerator pedal when a target location related to deceleration of the electrically-powered vehicle (which may be, for example, the target stop location D6 shown in FIG. 2, at which the electrically-powered vehicle is stopped or a targe location at which deceleration of the electrically-powered vehicle is started). The regeneration increasing control is control to, when the target location related to deceleration of the electrically-powered vehicle is set, increase the braking force generated by the motor generator as compared to when the target location is not set. As shown in FIG. 4 to FIG. 5B, strong regeneration control (for example, the accelerator strong regeneration control) is control to, when the strong regeneration mode is selected by the switch operating unit, increase the braking force (which may be, for example, the braking force generated by the motor generator, such as the second MG 30, or the braking force of engine braking) in a state where the accelerator pedal is released as compared to the normal mode.

As shown in FIG. 4, FIG. 6, and FIG. 8, the control apparatus executes the strong regeneration control (for example, step S112 of FIG. 4) when the strong regeneration mode is selected by the switch operating unit, and does not execute the look-ahead deceleration assistance control when the strong regeneration mode is selected by the switch operating unit (for example, when it is determined in step S123 of FIG. 6 that the accelerator strong regeneration control is being executed, the look-ahead deceleration assistance control is not executed in step S125, or, when it is determined in step S127 that the accelerator strong regeneration control is started, the look-ahead deceleration assistance control is interrupted in step S128, see (B) of FIG. 8 to (E) of FIG. 8).

Thus, when the strong regeneration control is being executed in the strong regeneration mode, the look-ahead deceleration assistance control may be configured not to be executed. As a result, it is possible to avoid concerns about interference of control, and it is possible to avoid a sense of discomfort experienced by the driver.

(2) As shown in FIG. 6 and FIG. 8, the control apparatus does not start the look-ahead deceleration assistance control when the strong regeneration mode is selected by the switch operating unit at the timing at which the accelerator-off guidance control is able to be started (for example, when it is determined in step S123 of FIG. 6 that the accelerator strong regeneration control is being executed, the look-ahead deceleration assistance control is not executed in step S125, see (B) of FIG. 8 and (D) of FIG. 8). When the look-ahead deceleration assistance control is not started, and when the normal mode is selected by the switch operating unit before the timing to end the look-ahead deceleration assistance control, the control apparatus does not execute the accelerator-off guidance control (for example, when it is determined in step S131 of FIG. 6 that the assistance prohibition history flag is in the on state, the accelerator-off guidance display is not started in step S134 even when it is determined in step S132 that the accelerator strong regeneration control is ended, see (D) of FIG. 8). Thus, it is possible to avoid a sense of discomfort experienced by the driver.

(3) As shown in FIG. 6 and FIG. 8, when the look-ahead deceleration assistance control is not started, the control apparatus executes the regeneration increasing control when the normal mode is selected by the switch operating unit before the timing to end the look-ahead deceleration assistance control (for example, when it is determined in step S131 of FIG. 6 that the assistance prohibition history flag is in the on state, and when it is determined in step S132 that the accelerator strong regeneration control is ended, the regeneration increasing control is started in step S134, see (D) FIG. 8). Thus, it is possible to avoid a sense of discomfort experienced by the driver.

(4) As shown in FIG. 4, FIG. 6, and FIG. 8, a control method that is executed by a control apparatus of an electrically-powered vehicle includes, when a strong regeneration mode is selected by a switch operating unit, executing strong regeneration control by the control apparatus (for example, step S112 of FIG. 4) and, when the strong regeneration mode is selected by the switch operating unit, prohibiting look-ahead deceleration assistance control (for example, step S127 to step S129, step S123, and step S130 in FIG. 6).

The above-described embodiments may be implemented in combination as needed. The embodiments described above are illustrative and not restrictive in all respects. The scope of the disclosure is not defined by the description of the above-described embodiments, and is defined by the appended claims. The scope of the disclosure is intended to encompass all modifications within the scope of the appended claims and equivalents thereof

What is claimed is:

1. A control apparatus for an electrically-powered vehicle, the electrically-powered vehicle including
a motor generator configured to generate a driving force of the electrically-powered vehicle by receiving a supply of electric power and generate a braking force by generating an electric power,
an accelerator pedal configured to receive an acceleration request from a driver, and
a switch operating unit configured to receive driver's operation to switch between a normal mode and a strong regeneration mode,
look-ahead deceleration assistance control includes accelerator-off guidance control and regeneration increasing control,
the accelerator-off guidance control is control to, when a target location related to deceleration of the electrically-powered vehicle is set, notify the driver of information prompting the driver to release the accelerator pedal,
the regeneration increasing control is control to, when the target location related to deceleration of the electrically-powered vehicle is set, increase the braking force generated by the motor generator as compared to when the target location is not set,
the strong regeneration control is control to, when the strong regeneration mode is set by the switch operating unit, increase the braking force in a state where the accelerator pedal is released as compared to the normal mode,
the control apparatus is configured to, when the strong regeneration mode is set by the switch operating unit, execute the strong regeneration control, and
the control apparatus is configured to, when the strong regeneration mode is set by the switch operating unit, not execute the look-ahead deceleration assistance control.

2. The control apparatus according to claim 1, wherein:
the control apparatus is configured to, control to, when the strong regeneration mode is set by the switch operating unit at a timing at which the accelerator-off guidance control is able to be started, not start the look-ahead deceleration assistance control, and
the control apparatus is configured to, when the look-ahead deceleration assistance control is not started, and when the normal mode is set by the switch operating unit before a timing at which the look-ahead deceleration assistance control is ended, not execute the accelerator-off guidance control.

3. The control apparatus according to claim 2, wherein the control apparatus is configured to, when the look-ahead deceleration assistance control is not started, and when the normal mode is set by the switch operating unit before the timing at which the look-ahead deceleration assistance control is ended, execute the regeneration increasing control.

4. An electrically-powered vehicle comprising:
a motor generator configured to generate a driving force of the electrically-powered vehicle by receiving a supply of electric power and generate a braking force by generating an electric power;
an accelerator pedal configured to receive an acceleration request from a driver;
a switch operating unit configured to receive driver's operation to switch between a normal mode and a strong regeneration mode; and
a control apparatus configured to control the motor generator, wherein:
look-ahead deceleration assistance control includes accelerator-off guidance control and regeneration increasing control;
the accelerator-off guidance control is control to, when a target location related to deceleration of the electrically-powered vehicle is set, notify the driver of information prompting the driver to release the accelerator pedal;
the regeneration increasing control is control to, when the target location related to deceleration of the electrically-powered vehicle is set, increase the braking force generated by the motor generator as compared to when the target location is not set;
the strong regeneration control is control to, when the strong regeneration mode is set by the switch operating unit, increase the braking force in a state where the accelerator pedal is released as compared to the normal mode;
the control apparatus is configured to, when the strong regeneration mode is set by the switch operating unit, execute the strong regeneration control; and
the control apparatus is configured to, when the strong regeneration mode is set by the switch operating unit, not execute the look-ahead deceleration assistance control.

5. A control method for an electrically-powered vehicle, the electrically-powered vehicle including
a motor generator configured to generate a driving force of the electrically-powered vehicle by receiving a supply of electric power and generate a braking force by generating an electric power,
an accelerator pedal configured to receive an acceleration request from a driver, and
a switch operating unit configured to receive driver's operation to switch between a normal mode and a strong regeneration mode,
look-ahead deceleration assistance control includes accelerator-off guidance control and regeneration increasing control,
the accelerator-off guidance control is control to, when a target location related to deceleration of the electrically-powered vehicle is set, notify the driver of information prompting the driver to release the accelerator pedal,
the regeneration increasing control is control to, when the target location related to deceleration of the electrically-powered vehicle is set, increase the braking force generated by the motor generator as compared to when the target location is not set,
the strong regeneration control is control to, when the strong regeneration mode is set by the switch operating unit, increase the braking force in a state where the accelerator pedal is released as compared to the normal mode, the control method comprising:
when the strong regeneration mode is set by the switch operating unit, executing the strong regeneration control by the control apparatus; and
when the strong regeneration mode is set by the switch operating unit, prohibiting the look-ahead deceleration assistance control by the control apparatus.
